(19) United States
(12) Patent Application Publication
(10) Pub. No.: US 2017/0192387 A1
(43) Pub. Date: Jul. 6, 2017

(54) FIXING DEVICE

(71) Applicant: CANON KABUSHIKI KAISHA, Tokyo (JP)

(72) Inventor: Kenichi Tanaka, Ushiku-shi (JP)

(21) Appl. No.: 15/461,918

(22) Filed: Mar. 17, 2017

Related U.S. Application Data
(63) Continuation of application No. PCT/JP2015/078416, filed on Sep. 30, 2015.

(30) Foreign Application Priority Data
Sep. 30, 2014 (JP) 2014-200048

(51) Int. Cl. G03G 15/20

(52) U.S. Cl. CPC G03G 21/206; G03G 15/2039

(57) ABSTRACT

In a fixing device, a wind shielding member 908 for suppressing action of air by a fan 903 onto a thermistor 922 for detecting a temperature of a pressing roller 920 is provided. The wind shielding member 908 includes a recessed portion 908c and a partitioning portion 908a for partitioning this recessed portion 908c into a plurality of spaces 908m.

### TECHNICAL FIELD

The present invention relates to a fixing device for fixing a toner image on a recording material.

### BACKGROUND ART

In an apparatus described in Japanese Laid-Open Patent Application 2006-119430, a fixing device is provided with an air blowing fan (air blowing portion) for cooling a pressing roller. Further, in this apparatus, a heating condition of the pressing roller is controlled by a sensor (detecting portion) for detecting a temperature of the pressing roller.

The present inventor has found that in such a constitution, a phenomenon that air by the air blowing fan acts on the sensor and the sensor detects a temperature so as to be lower than an actual temperature can arise.

### SUMMARY OF THE INVENTION

### Problem to be Solved by the Invention

An object of the present invention is to provide a fixing device capable of suppressing action of air by an air blowing portion on a detecting portion.

### Means for Solving the Problem

According to the present invention, there is provided a fixing device comprising: first and second rotatable members configured to form a nip for fixing a toner image on a recording material; a detecting portion configured to detect a temperature of the first rotatable member; an air blowing portion configured to blow air toward the first rotatable member; a suppressing portion provided spaced from the first rotatable member along a circumferential direction of the first rotatable member and configured to suppress movement of the air from the air blowing portion toward the detecting portion, wherein the suppressing portion includes a recessed portion opening toward a peripheral surface of the first rotatable member and a partitioning portion configured to partition the recessed portion into a plurality of spaces arranged in the circumferential direction of the first rotatable member.

### Effect of the Invention

According to the present invention, it is possible to provide the fixing device capable of suppressing the action of the air by the air blowing portion on the detecting portion.

### BRIEF DESCRIPTION OF THE DRAWINGS

FIG. 1 is an illustration of a structure of an image forming apparatus.

FIG. 2 is an illustration of a structure of a fixing device in Embodiment 1.

FIG. 3 is an illustration of the fixing device in a stand-by state.

FIG. 4 is a flowchart of control of the fixing device.

FIG. 5 is a perspective view of a wind shielding member.

FIG. 6 is an illustration of a flow of air during the stand-by state.

FIG. 7 is an illustration of the flow of the air during image formation.

FIG. 8 is an illustration of a structure of a fixing device in a comparison example.

FIG. 9 is an illustration of an arrangement of a wind shielding member in Embodiment 2.

### EMBODIMENTS FOR CARRYING OUT THE INVENTION

### Embodiment 1

In the following, with reference to the drawings, an embodiment of the present invention will be described specifically.

### (Image Forming Apparatus)

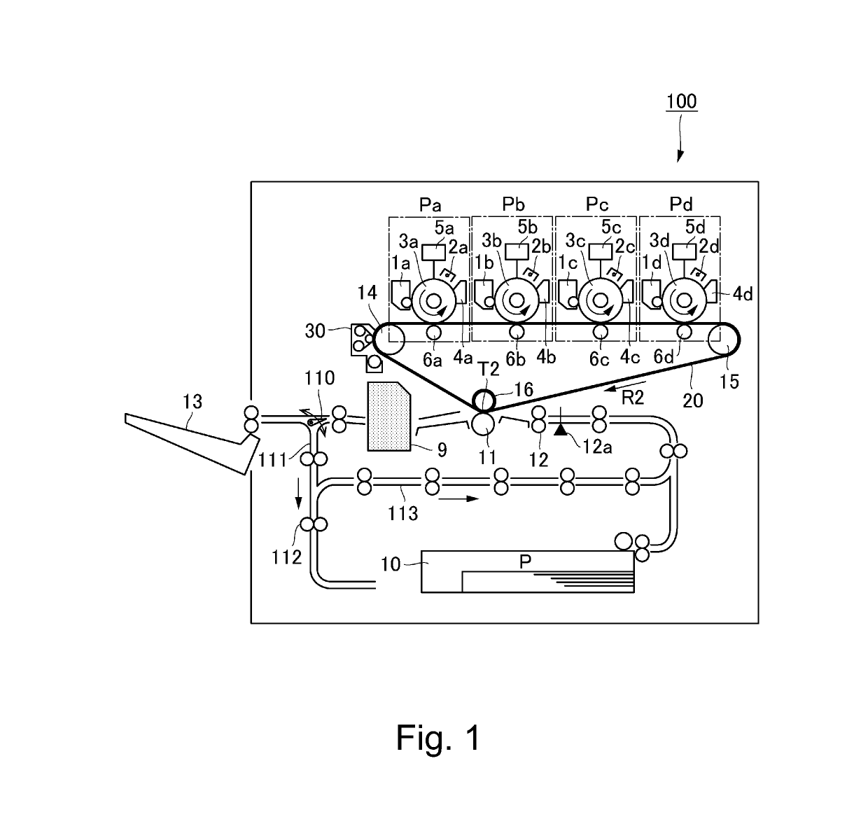

FIG. 1 is an illustration of a structure of an image forming apparatus. As shown in FIG. 1, an image forming apparatus 100 is a tandem-type full-color printer of an intermediary transfer type in which image forming apparatus Pa, Pb, Pc, Pd of yellow, magenta, cyan, black are arranged along an intermediary transfer belt 20.

At the image forming portion Pa, a yellow toner image is formed on a photosensitive drum 3a and is primary-transferred onto the intermediary transfer belt 20. At the image forming portion Pb, a magenta toner image is formed on a photosensitive drum 3b and is primary-transferred onto the intermediary transfer belt 20. At the image forming portion Pc and Pd, a cyan toner image and a black toner image on the photosensitive drums 3c and 3d, respectively, and are primary-transferred onto the intermediary transfer belt 20.

A recording material (sheet, transfer(-receiving) material) P is taken out one by one from a cassette 10 and is on stand-by at a registration roller 12. The recording material P is fed by the registration roller 12 to a secondary transfer portion T2 in timing with the toner images on the intermediary transfer belt 20, and the toner images are secondary-transferred onto the recording material P. The recording material P on which the toner images of the four colors are secondary-transferred is fed to a fixing device 9 and is heated and pressed by the fixing device 9, so that an image is fixed on the recording material P, and thereafter is discharged on a tray 13.

In double-side printing, the recording material on which the images are fixed at a front surface thereof by the fixing device 9 is sent into a reverse feeding path 111 and is switched back, and then passes through a feeding path 113 in a state in which a leading end and a trailing end are reversed and in which the front surface and a back surface are reversed, and is on stand-by at the registration roller 12. Then, the recording material is fed again to the secondary transfer portion T2, where the toner images are transferred onto the back surface of the recording material and are fixed on the back surface of the recording material by the fixing device 9, and thereafter, the recording material is discharged on the tray 13 at an outer portion of the apparatus (printer).

### (Image Forming Portion)

The image forming portions Pa, Pb, Pc, Pd have substantially the same constitution except that the colors of the toners used in developing devices 1a, 1b, 1c, 1d are yellow, magenta, cyan, black which are different from each other. In the following, the image forming portion Pa for yellow will be described, and redundant description relating to other image forming portions Pb, Pc, Pd will be omitted.

At the image forming portion Pa, at a periphery of the photosensitive drum 3a, a corona charger 2a, an exposure device 5a, the developing device 1a, a transfer roller 6a and a drum cleaning device 4a are provided.

The corona charger 2a electrically charges a surface of the photosensitive drum 3a to a uniform potential. The exposure device 5a writes the electrostatic image for the image on the photosensitive drum 3a by scanning the photosensitive drum surface with a laser beam. The developing device 1a develops the electrostatic image into the toner image on the photosensitive drum 3a by transferring the toner on the electrostatic image on the photosensitive drum 3a. The transfer roller 6a primary-transfers the toner image from the photosensitive drum 3a onto the intermediary transfer belt 20 under application of a voltage of an opposite polarity to a charge polarity of the toner.

The intermediary transfer belt 20 is extended around and supported by a tension roller 14, a driving roller 15 and an opposing roller 16, and is driven by the driving roller 15, so that the intermediary transfer belt 20 rotates in an arrow direction. A secondary transfer roller 11 press-contacts the intermediary transfer belt 20 supported by the opposing roller 16 and forms the secondary transfer portion T2. A belt cleaning device 30 rubs the intermediary transfer belt 20 with a cleaning web and thus removes a transfer residual toner passed through the secondary transfer portion T2.

### (Fixing Device)

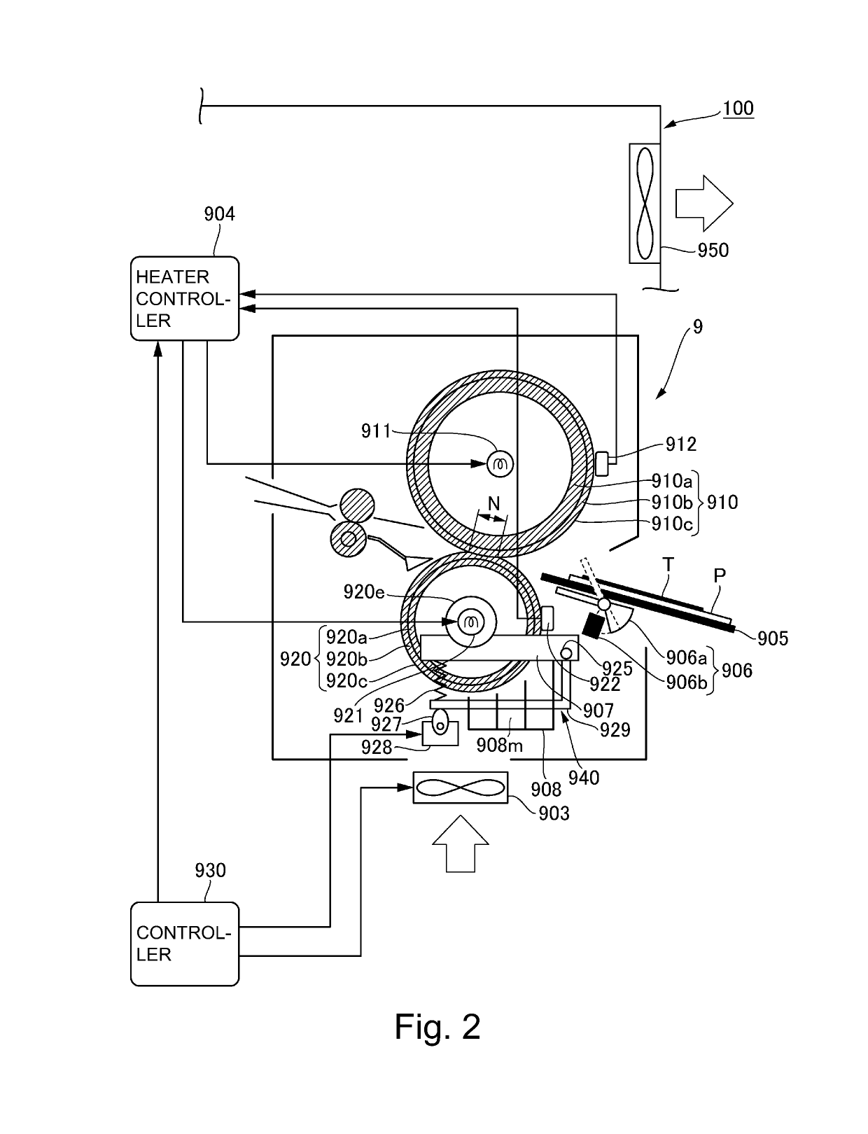

FIG. 2 is an illustration of a structure of the fixing device. As shown in FIG. 2, an entrance guide 905 which is an example of a guiding member is fixed in a positional relationship with a fixing roller 910 and guides the recording material to a fixing nip N. The recording material P is guided by the entrance guide 905 and is induced into the fixing nip N, and is nipped and fed by the fixing roller 910 and a pressing roller 920 which are a pair of rotatable members. A toner image T on the recording material P is heated and pressed in a process of passing through the fixing nip N, so that the image is fixed on the surface of the recording material P.

The fixing roller 910 contacts a toner image carrying surface of the recording material and heats the recording material. The fixing roller 910 includes a core metal 910a formed with a pipe member of aluminum, iron or the like and an elastic layer 910b which is disposed in an outer side of the core metal 910a and which is formed with a heat-resistant elastic member of a silicone rubber, a fluorine-containing rubber or the like, and the surface of the elastic layer 910b is coated with a parting layer 910c of a fluorine-containing material such as PFA or PTFE. The fixing roller 910 is rotated in an arrow A direction by an unshown driving mechanism. The pressing roller 920 is disposed so that the pressing roller 920 can press-contact the fixing roller 910 and can be spaced from the fixing roller 910, and press-contacts the fixing roller 910 and thus forms the fixing nip N, so that the pressing roller 920 is rotated in an arrow B direction by the fixing roller 910.

The pressing roller 920 forms the fixing nip N, which is an example of a recording material nip, between itself and the fixing roller 910. The pressing roller 920 includes, similarly as the fixing roller 910, a core metal 920a formed with a pipe member, an elastic layer 920b of a heat-resistant elastic member disposed in an outer side of the core metal 920a, and a parting layer 920c of a fluorine-containing resin material coated on a surface of the elastic layer 920b.

A recording material detecting portion 906 is provided below the entrance guide 905 and detects passing of the recording material P. The recording material detecting portion 906 is constituted by a detecting flag 906a and a photo-interruptor 906b, and when the recording material P passes through the detecting flag 906a, the detecting flag 906a falls down, so that the photo-interruptor 906b detects transmitted light and thus detects the passing of the recording material P.

Inside the fixing roller 910, a heater 911 is provided non-rotatably. The heater 911 radiates infrared rays by energization and heats the fixing roller 910 from an inside of the fixing roller 910. A thermistor 912 is provided spaced from the fixing roller 910. The thermistor 912 detects a surface temperature of the fixing roller 910. A heater controller 904 effects ON/OFF control of electric power supply to the heater 911 on the basis of an output of the thermistor 912, and maintains the surface temperature of the fixing roller 910 at a target temperature (printing temperature) during fixing or a waiting (stand-by) temperature during non-fixing. The heater controller 904 controls the electric power supply to the heater 911 on the basis of the surface temperature detected by the thermistor 912, and maintains the surface temperature of the fixing roller 910 at a temperature suitable for fixing of the toner.

Also as regards the pressing roller 920, similarly, a heater 921 is provided non-rotatably, and a thermistor 922 is provided. The thermistor 922 which is an example of a detecting portion contacts a peripheral surface of the pressing roller 920 and detects a temperature of the pressing roller 920. Incidentally, the thermistor 922 may also be disposed spaced from the pressing roller 920. The heater controller 904 which is an example of a temperature controller controls heating of the pressing roller 920 on the basis of an output of the thermistor 922. The heater controller 904 effects ON/OFF control of electric power supply to the heater 921 on the basis of an output of the thermistor 922, and maintains the surface temperature of the pressing roller 920 at a target temperature lower than the target temperature of the fixing roller 910a. The heater controller 904 controls the electric power supply to the heater 921 on the basis of the surface temperature detected by the thermistor 922, and maintains the surface temperature of the pressing roller 920 at a temperature at which the fixed image is melted again.

As shown in FIG. 1, in the case of the double-side printing, the recording material on which a first surface image is fixed by the fixing device 9 is guided into the reverse feeding path 111 by a flapper 110, and the toner image is transferred onto a second surface and then the image is fixed by the fixing device 9. In this case, when the surface temperature of the pressing roller 920 is excessively high, there is a possibility that the first surface image contacts the pressing roller 920 and is melted again and thus is disturbed. For this reason, relative to the surface temperature of the fixing roller 910, the surface temperature of the pressing roller 920 is set at a lower value.

Here, during a heating process of plain paper and during a heating process stand-by of the plain paper, the target temperature of the fixing roller 910 is 170° C. and the target temperature of the pressing roller 920 is 100° C. The heater controller 904 controls outputs of the heaters 911 and 921 so that detection temperatures of the thermistors 912 and 922 converge to the respective target temperatures.

### (Contact-and-Separation Mechanism)

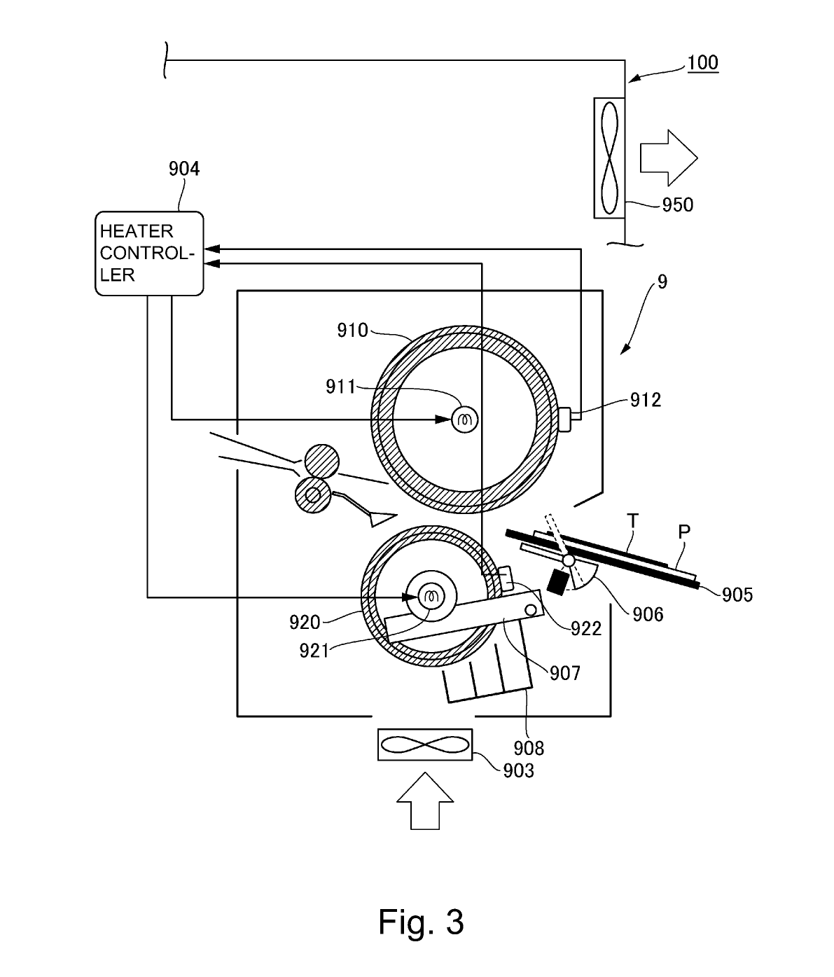

FIG. 3 is an illustration of the fixing device in the stand-by state. As shown in FIG. 3, when the fixing device 9 awaits in the stand-by state in which image fixing on the plain paper can be immediately started, the pressing roller 920 is spaced from the fixing roller 910. When a state in which the pressing roller 920 low in temperature press-contacts the fixing roller 910 and rotates is maintained, even when the pressing roller 920 is externally heated and heating of the pressing roller 920 is turned off, the surface temperature of the pressing roller 920 exceeds the target temperature. During the heating process stand-by of the plain paper, the pressing roller 920 is heated by the fixing roller 910 of 170° C. in surface temperature, so that the surface temperature of the pressing roller 920 exceeds 130° C.

As shown in FIG. 2, the pressing roller 920 moves between a press-contact position and a spaced position relative to the fixing roller 910 with rotational movement of a pressing arm 907 as a contact-and-separation mechanism (moving mechanism). Bearings 920e rotatably supporting both end portions of the pressing roller 920 are fixed to the pressing arms 907 rotatable about rotation shafts 925. Each pressing arm 907 is moves a rotational movement end upward and downward via a pressing spring 926 by rotating a pressing cam 927 by a driving motor 928.

A controller 930 controls the driving motor 928 and rotates the pressing arm 907, and thus switches press-contact and spacing of the pressing roller 920 relative to the fixing roller 910. The controller 930 causes the pressing roller 920 to press-contact the fixing roller 910 at timing immediately before feeding of the recording material, on which the toner image is transferred, to the fixing device 9, so that the fixing nip N is formed. Further, the controller 930 maintains the press-contact state during continuous passing of the recording material through the fixing nip N. Then, when a series of fixing processes of the recording materials is ended, the controller 930 spaces the pressing roller 920 from the fixing roller 910 at timing when a final recording material passes through the fixing nip N.

As shown in FIG. 2, the thermistor 922 is fixed and mounted in a positional relationship with the pressing arm 907. The thermistor 922 is fixed in the positional relationship with the pressing arm 907, and therefore moves while following a rotation movement operation of the press-contact and spacing of the pressing roller 920, so that the thermistor 922 rotationally moves integrally with the pressing arm 907. For this reason, as shown in FIG. 3, the thermistor 922 maintains the same contact state with the pressing roller 920 through a process in which the pressing roller 920 moves to the spaced position or through a process in which the pressing roller 920 moves to the press-contact position.

The controller 930 rotationally moves the pressing arm 907 downward as shown in FIG. 3. The pressing roller 920 rotates in a state in which the pressing roller 920 is moved to a position spaced from the fixing roller 910 and waits for a start of a subsequent heating process.

### (Cooling Fan)

As shown in FIG. 2, below the fixing device 9, a cooling fan 903 as an air blowing portion for blowing air toward the pressing roller 920 is provided. The cooling fan 903 which is an example of the air blowing portion blows the air toward the pressing roller 920. The cooling fan 903 is an axial fan, and blows the air to the pressing roller 920 through an unshown air filter and forms an air flow (air current) along a peripheral surface of the pressing roller 920, and thus cools the pressing roller 920.

An exhaust fan 950 exhausts the air, to an outside, inside a casing of the image forming apparatus 100 in which the fixing device 9 is disposed, so that heat of the fixing device 9 heated by the heaters 911 and 921 is prevented from being accumulated in the casing of the image forming apparatus 100.

When the target temperature for temperature adjustment of the fixing roller 910 is changed, thereafter, until the surface temperature of the fixing roller 910 converges to a new target temperature, image formation is interrupted and downtime generates. Here, in the case where the target temperature is changed to a high value, by increasing supplied electric power for heating the fixing roller 910, the downtime can be quickly eliminated. However, in the case where the target temperature is lowered, when the fixing roller 910 waits for natural cooling, the downtime endlessly elongates. Therefore, in Embodiment 1, the pressing roller 920 air-cooled by the cooling fan 903 is press-contacted to the fixing roller 910, so that a temperature lowering of the fixing roller 910 is promoted. In the case where the target temperature for temperature adjustment of the fixing roller 910 is lowered, the controller 930 causes the pressing roller 920 to press-contact the fixing roller 910 and to rotate the pressing roller 920, and at the same time, turns on the cooling fan 903 and thus cools the pressing roller 920, so that the fixing roller 910 is forcedly cooled.

Further, in the case where the target temperatures of the fixing roller 910 and the pressing roller 920 are different from each other, heat is conducted from the fixing roller 910 high in target temperature to the pressing roller 920 low in target temperature during printing, and the surface temperature of the pressing roller 920 exceeds the target temperature thereof in some instances. Therefore, in Embodiment 1, the air is blown from the cooling fan 903 to the pressing roller 920 during the printing, so that forced cooling is carried out.

The controller 930 which is an example of an air blowing controller controls the air blowing of the cooling fan 903 on the basis of an output of the thermistor 922 which is an example of the detecting portion. In the continuous fixing process, in the case where the surface temperature of the pressing roller 920 detected by the thermistor 922 is increased relative to the target temperature by a certain temperature or more (in the case where the surface temperature is not less than a threshold temperature higher than the target temperature), the controller causes the cooling fan 903 to blow the air toward the pressing roller 920, so that the pressing roller 920 is forcedly cooled. The controller 930 which is an example of the air blowing controller controls ON/OFF of the cooling fan 903 on the basis of an output of the thermistor 922.

### (Control of Fixing Device)

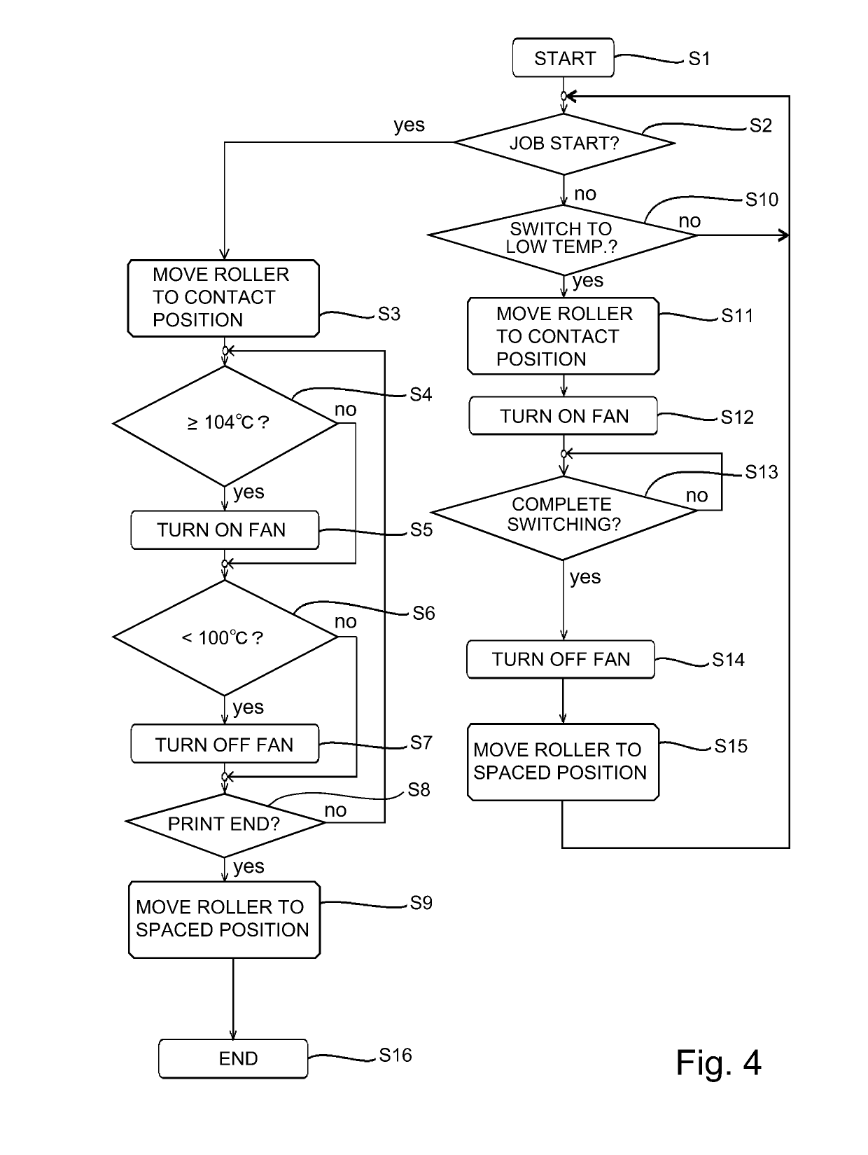

FIG. 4 is a flowchart of the control of the fixing device.

As shown in FIG. 4 with reference to FIG. 2, the fixing device 9 waits for a start of image formation in the image forming apparatus (100: FIG. 1) in a state in which the pressing roller 920 is spaced from the fixing roller 910 and these rollers are maintained at the respective target temperatures. When data of a print job are sent from an external computer or the like (S1), the image forming apparatus (100) carries out image formation designated by the print job.

When a detection temperature of the thermistor 912 falls within a range of ±1° C. with respect to the target temperature of the fixing roller 910 for the recording material designated by the print job, the controller 930 discriminates that the job can be started (yes of S2).

The controller 930 causes the pressing roller 920 to press-contact the fixing roller 910, so that the fixing nip N is formed (S3).

Thereafter, the toner images are formed at the image forming portions Pa, Pb, Pc, Pd, and the recording materials on which the toner images are transferred are successively sent into the fixing device 9, so that the images are fixed on the recording materials. During execution of the continuous fixing process, when the heating process of thin paper is continued, heat of the fixing roller 910 excessively flows into the pressing roller 920, so that the surface temperature of the pressing roller 920 exceeds the target temperature of 100° C. in some cases.

For that reason, when a detection temperature of the thermistor 922 exceeds 104° C. (yes of S4), the controller 930 turns on the cooling fan 903 (S5), and when the cooling is successful and the detection temperature is below 100° C. (yes of S6), the controller 930 turns off the cooling fan 903 (S7). Thus, by controlling the cooling fan 903, the continuous recording material fixing process is continued.

When the image formation (print-out) designated by the job is ended (yes of S8), the controller 930 moves the pressing roller 920 from the fixing roller 910 to the spaced position and goes to a stand-by state (S9). At this time, when the cooling fan 903 rotates, the cooling fan 903 is turned off at the time when the detection temperature of the thermistor 922 is below 100° C.

The controller 930 discriminates that the job cannot be started unless the detection temperature of the thermistor 912 falls within the range of ±1° C. with respect to the target temperature of the fixing roller 910 for the recording material designated by the print job (no of S2).

In the case where the recording material designated by the print job requires a change in target temperature for temperature adjustment of the fixing roller 910 (no of S2), the controller 930 discriminates whether the target temperature should be raised or lowered (S10). In the case where thick paper having a large weight per unit area is designated, the target temperature is raised. In the case where the target temperature is raised (no of S10), when the surface temperature of the fixing roller 910 reaches a new target temperature (yes of S2), the controller 930 causes the pressing roller 920 to press-contact the fixing roller 910, so that the fixing nip N is formed (S3).

In the case where thin paper having a small weight per unit area is designated, the target temperature is lowered. However, in the case where the target temperature is lowered (yes of S10), even when the heater 911 is turned off, the temperature of the fixing roller 910 is not readily lowered only by natural heat dissipation.

For this reason, the controller 930 causes the pressing roller 920, which is relatively coal, the press-contact the fixing roller 910, so that the fixing roller 910 is forcedly cooled from the surface thereof (S11). Further, the cooling fan 903 is turned on for cooling the pressing roller 920 increased in temperature by being heated by the fixing roller 910 (S12).

When the change in both of the surface temperatures of the fixing roller 910 and the pressing roller 920 to the changed target temperatures is completed (yes of S13), the controller 930 turns off the cooling fan 903 (S14), and moves the pressing roller 920 to the spaced position (S15). By this, switching to a newly set temperature is completed. When the surface temperature of the fixing roller 910 reaches the new target temperature (yes of S2), the controller 930 causes the pressing roller 920 to press-contact the fixing roller 910, so that the fixing nip N is formed (S3).

### (Detection Temperature Error of Thermistor)

In order to detect the surface temperature of the fixing roller 910, conventionally, a contact-type thermistor was disposed in contact with the surface of the fixing roller 910. However, in the case of the contact-type thermistor, during rotation of the fixing roller 910, the thermistor continuously rubs the surface of the fixing roller 910, so that when a foreign matter deposits on the rubbed portion, rubbing damage generates on the fixing roller 910 and is not preferable. For this reason, in recent years, a non-contact-type temperature sensor is employed in some instances.

The temperature sensors provided for the fixing roller 910 and the pressing roller 920 have been required, irrespective of the contact type and the non-contact type, to be small in thermal capacity and be high in responsiveness with speed-up of a process speed of the image forming apparatus 100.

In Embodiment 1, the thermistors 912 and 922 are small in thermal capacity and high in responsiveness, and sensitively react to thermal disturbance. For this reason, when the cooling fan 903 is actuated and the air is blown to the pressing roller 920, a part of the blown air flows to the thermistors 912 and 922 and generates the thermal disturbance, so that detection temperatures of the thermistors 912 and 922 are outputted as low values. As a result, an actual surface temperature of the fixing roller 910 temperature-adjusted at the same toner image is somewhat high during the turning-on of the cooling fan 903, so that toner offset such that a melted toner is transferred to the fixing roller 910 is liable to generate. Further, a glossiness of the outputted fixing image is different between the turning-on and the turning-off of the cooling fan 903.

Further, the thermistor 922 for detecting the temperature of the pressing roller 920 is disposed at a position close to the cooling fan 903, and therefore the thermistor 922 is move susceptible to the influence of the air blowing of the cooling fan 903.

### (Result of Study)

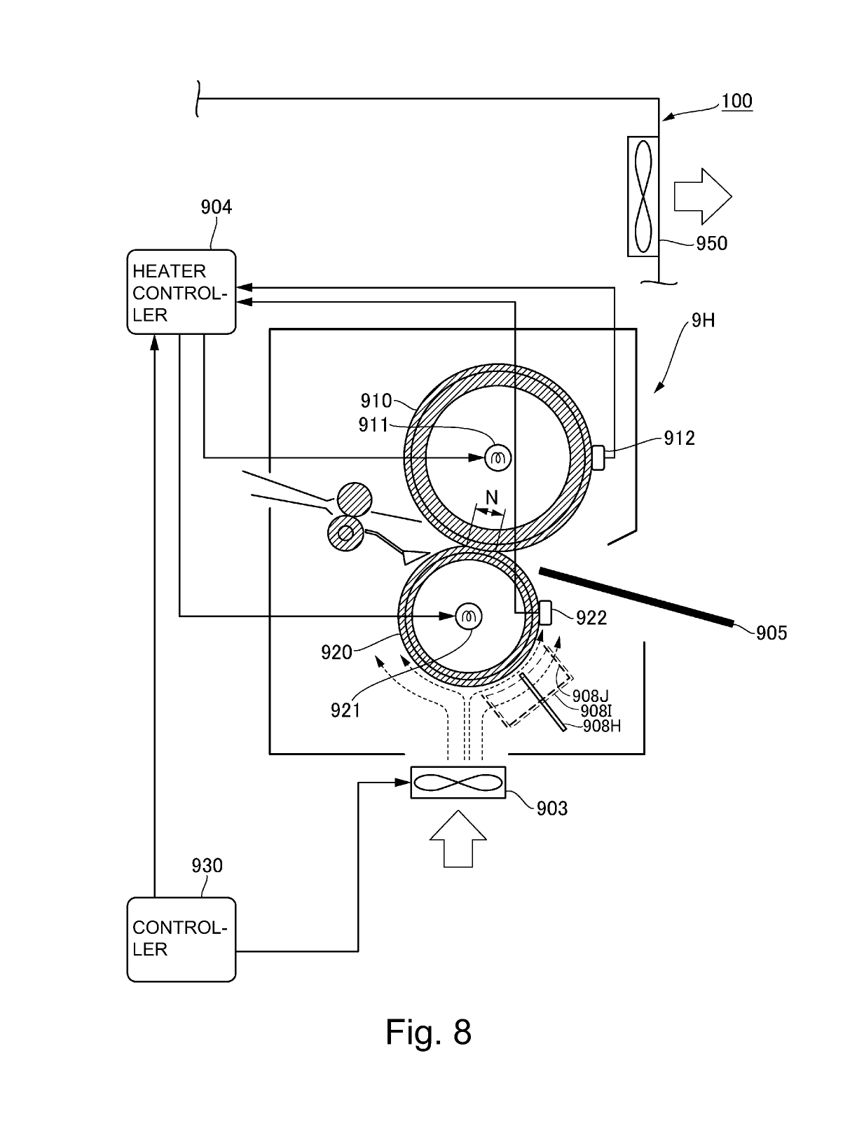

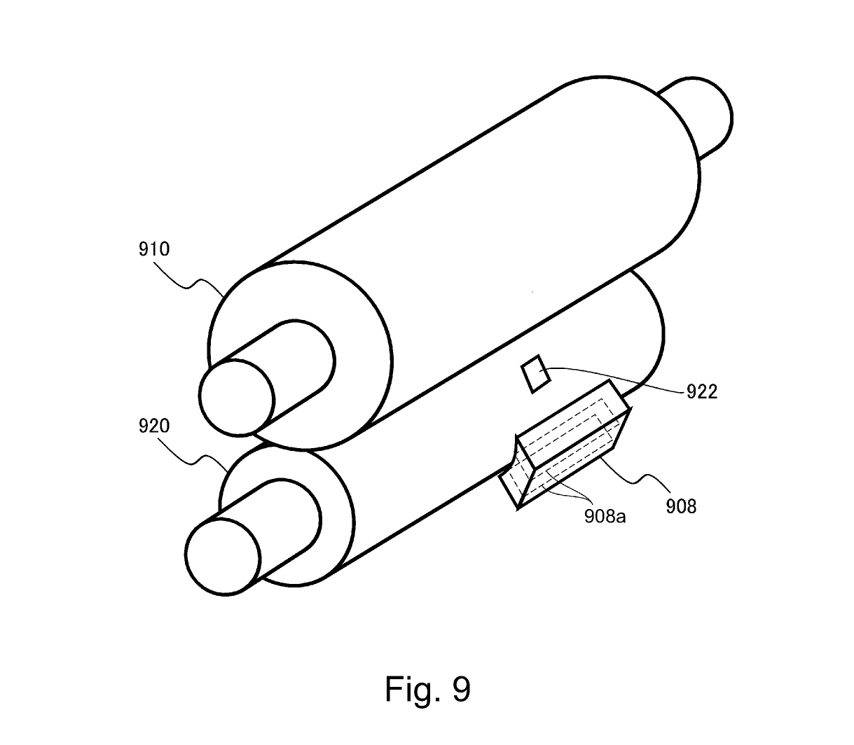

FIG. 8 is an illustration of a structure of a fixing device in a comparison example. As shown in FIG. 9, a fixing device 9H in the comparison example is constituted so as to be the same as the fixing device 9 in Embodiment 1 except that the wind shielding member 908 shown in FIG. 2 is not provided. For that reason, in FIG. 8, constituent members common to the fixing device 9 in Embodiment 1 are represented by the same symbols as those in FIG. 2 and will be omitted from redundant description.

As shown in FIG. 8, in the fixing device 9H in the comparison example, in the case where there is no wind shielding member 908 (908H, 908I, 908J), a part of air blowing of the cooling fan 903 flows to the thermistors 912 and 922 and cools the thermistors 912 and 922. For this reason, between during the turning-on and the turning-off of the cooling fan 903, the detection temperature of the thermistor 922 is different by 10° C. or more.

At this time, ON/OFF timing of the heater 911 controlled depending on the detection temperature of the thermistor 922 shifts toward a high-temperature side by 10° C., so that the surface temperature of the pressing roller 920 is temperature-adjusted to 110° C. Further, when the surface temperature of the pressing roller 920 does not reach 114° C. largely exceeding 104° C. which is a threshold, the cooling fan 903 is not turned on, so that the cooling fan 903 is turned off at 110° C., which is the surface temperature of the pressing roller 920, largely exceeding 100° C. which is a threshold.

As a result, the surface temperature of the pressing roller 920 shifts toward the high-temperature side, so that during double-side printing, the back-surface image on the recording material is softened and the surface damage of the pressing roller 920 is transferred on the recording material in some instances. Or, when the surface temperature of the pressing roller 920 shifts toward the high-temperature side and the target temperature for the temperature adjustment of the fixing roller 910 is lowered, even when the pressing roller 920 is contacted to the fixing roller 910, a lowering in temperature of the fixing roller 910 becomes slow in some instances.

Further, the air in the casing of the fixing device 9H is heated and natural convection generates, so that the natural convection leaks out from an upper gap and is caught by an exhaust fan 950, and thus is discharged to an outside of the apparatus. When the cooling fan 903 is actuated, an ascending air flow (air current) in an amount of flow largely exceeding an amount of the natural convection flows through the inside of the fixing device 9H and is discharged to the outside of the apparatus by the exhaust fan 950. For this reason, in the ON state of the cooling fan 903, compared with the OFF state, cool air in a large amount passes through the side of the thermistors 912 and 922 and flows upward. A flow of the ascending cool air generates the thermal disturbance to the thermistors 912 and 922, so that the detection temperatures are outputted as low values.

In Embodiment 1, the cooling fan 903 is operated when the temperature of the pressing roller 920 is excessively high (over heating) even during the printing and during the stand-by. For this reason, even when the pressing roller 920 is located at either of the spaced position and the press-contact position, it is desirable that erroneous detection of the thermistors 912 and 922 does not generate.

Therefore, as shown by a thick solid line in FIG. 8, a single plate of a wind shielding member 908H was provided between the cooling fan 903 and the thermistor 922 and shielding of the air blowing of the cooling fan 903 toward the thermistors 912 and 922 was studied. However, when thermal expansion, a mounting error and a clearance during mounting/demounting exchange of the pressing roller are taken into consideration, it is desirable that a gap of 1.5 mm or more is provided between a free end of the wind shielding member 908H and the pressing roller. Further, it was confirmed that when the gap of 1.5 mm was provided between the free end of the wind shielding member 908H and the pressing roller, the detection temperature of the thermistor 922 is influenced by the air blowing passing through the gap between the free end of the wind shielding member 908H and the pressing roller.

Further, as shown by a thin broken line in FIG. 8, a block-like wind shielding member 908I was provided between the cooling fan 903 and the thermistor 922 and shielding of the air blowing of the cooling fan 903 toward the thermistors 912 and 922 was studied. However, it was confirmed that when the gap of 1.5 mm was provided between the wind shielding member 908I and the pressing roller, the detection temperature of the thermistor 922 is influenced by the air blowing passing through the gap between the free end of the wind shielding member 908I and the pressing roller.

Therefore, as shown by a thick broken line in FIG. 8, a U-character groove-shaped wind shielding member 908J was provided between the cooling fan 903 and the thermistor 922 and shielding of the air blowing of the cooling fan 903 toward the thermistors 912 and 922 was studied. However, it was confirmed that when the gap of 1.5 mm was provided between the wind shielding member 908J and the pressing roller, the detection temperature of the thermistor 922 is influenced by the air blowing passing through the gap between the free end of the wind shielding member 908J and the pressing roller.

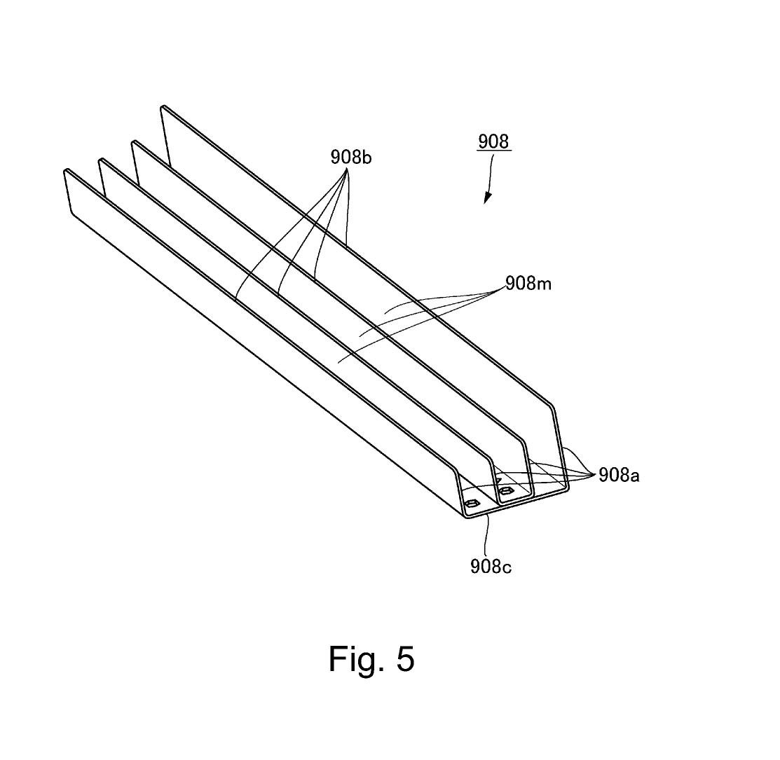

Then, two partitioning plates were added as shown in FIG. 5 in the inside of the wind shielding member 908J shown in FIG. 8 and thus a recessed member in which a plurality of U-character grooves were arranged in a rotational direction of the pressing roller 920 was prepared by way of experiment and was similarly subjected to an evaluation experiment. Then, it was confirmed that even when the gap of 1.5 mm was provided between the prepared wind shielding member and the pressing roller, there was no influence on the detection temperature of the temperature sensor.

TABLE 1

| Winding shielding member | ABSE*¹ |
|---|---|
| Not provided | x |
| PWSM*² 908H | x |
| BWSM*³ 908I | x |
| SGWSM*⁴ 908J | Δ |
| TGWSM*⁵ 908 | ⊚ |

*¹″ABSE″ is the air blowing shielding effect.
*²″PWSM″ is the plate-like wind shielding member.
*³″BWSM″ is the block-like wind shielding member.
*⁴″SGWSM″ is the single-groove wind shielding member.
*⁵″TGWSM″ is the triple-groove wind shielding member.

Therefore, in Embodiment 1, as shown in FIG. 2, the wind shielding member 908 having a shape that the plurality of U-character grooves are arranged is provided between the cooling fan 903 and the thermistor 922, so that the air blowing of the cooling fan 903 toward the thermistors 912 and 922 is shielded.

### (Wind Shielding Member)

FIG. 5 is a perspective view of the wind shielding member as a suppressing portion. As shown in FIG. 2, the wind shielding member 908 is fixedly mounted in a positional relationship with the pressing arm 907. The wind shielding member 908 is fixed in the positional relationship with the pressing arm 907, and therefore moves while following a rotational movement operation of the press-contact and the spacing of the pressing roller 920. The wind shielding member 908 follows an operation movement of the pressing roller 920 to the spaced position and integrally rotates with the pressing arm 907. For this reason, as shown in FIG. 3, through a process in which the pressing roller 920 moves to the spaced position or a process in which the pressing roller 920 moves to the press-contact position, the thermistor 922 maintains an opposing state to the pressing roller 920 with the same gap.

As shown in FIG. 5 with reference to FIG. 2, the wind shielding member 908 is disposed between the cooling fan 903 and the temperature detecting portion for the pressing roller 920 with the gap between itself and a peripheral surface of the pressing roller 920 and shields the air blowing of the cooling fan 903 toward the thermistor 922.

The wind shielding member 908 is provided along a circumferential direction of the pressing roller 920 and spaced from the pressing roller. Further, the wind shielding member 908 is provided with a recessed portion (recess-shaped portion) which opens toward the peripheral surface of the pressing roller 920. This recessed portion is partitioned into a plurality of rooms (hereinafter referred to as spaces) with respect to the circumferential direction of the pressing roller by a plurality of wind shielding plates (partitioning portions) 908a. The spaces 908m are formed so as to be adjacent to each other with respect to the circumferential direction and to be arranged at two or more positions. The wind shielding member 908 includes a bottom plate portion 908c. The plurality of wind shielding plates 908a are arranged with intervals with respect to the rotational direction of the pressing roller 920. Edges of the wind shielding plates 908a opposite from the bottom plate 908c are closest portions 908b. The closest portions 902b are disposed with a predetermined gap from the surface of the pressing roller 920.

In this embodiment, the wind shielding member 908 includes the three spaces 908 in which both end portions thereof with respect to the longitudinal direction of the pressing roller 920 are open (there is no wall). The three spaces 908m are formed by subjecting large and small two aluminum plates bent in a U-shape to edge folding connection at a plurality of positions.

As shown in FIG. 2, the wind shielding member 908 is mounted to the pressing arm 907, and therefore moves while following the rotational movement operation for the press-contact and the spacing of the pressing roller 920. As a result, the gap between the closest portions (908b: FIG. 5), of the wind shielding member 908 closest to the pressing roller 920, and the pressing roller 920 is kept at constant irrespective of the press-contact and spacing operation.

When a performance evaluation experiment was conducted using the wind shielding member 908 as described above, it was confirmed that when the gap between the closest portions 908b and the pressing roller 920 was not more than 2.0 mm, the air blowing of the cooling fan 903 had no influence on the detection temperature of the thermistor 912. It was confirmed that irrespective of ON/OFF of the cooling fan 903, the thermistor 922 was able to detect the temperature of the pressing roller 920 satisfactorily.

On the basis of this result of the experiment, the gap between the closest portions 908b and the pressing roller 920 was set at 1.5 mm. The gap between the closest portions 908b and the pressing roller 920 may desirably be set so as not to contact each other while being made small to the extent possible even when a variation in mounting tolerance and thermal expansion of the pressing roller 920 are taken into consideration. Setting of the gap is also possible by appropriately changing the gap depending on the structure of the fixing device, an air blowing amount of the cooling fan and responsiveness of the thermistor.

### (Flow of Air in Wind Shielding Member)

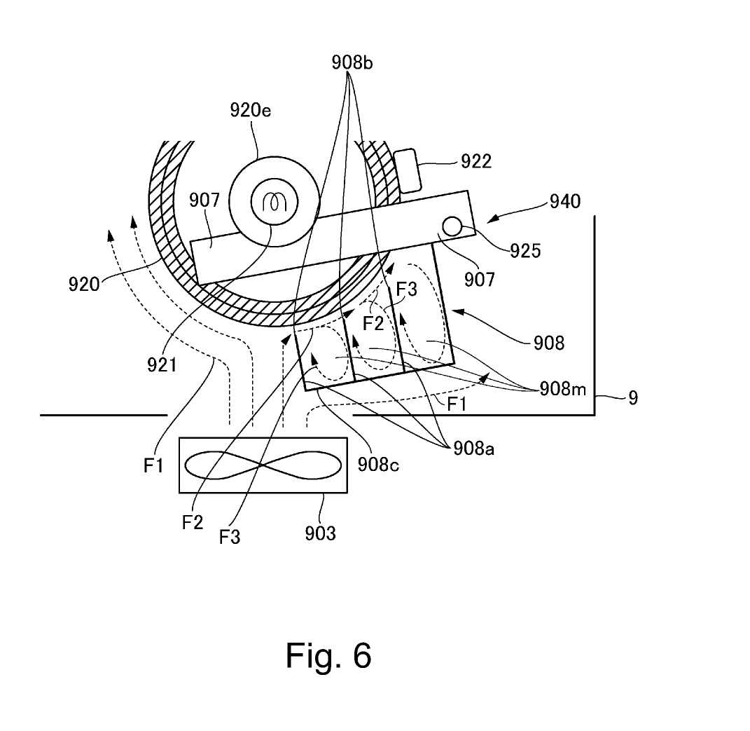

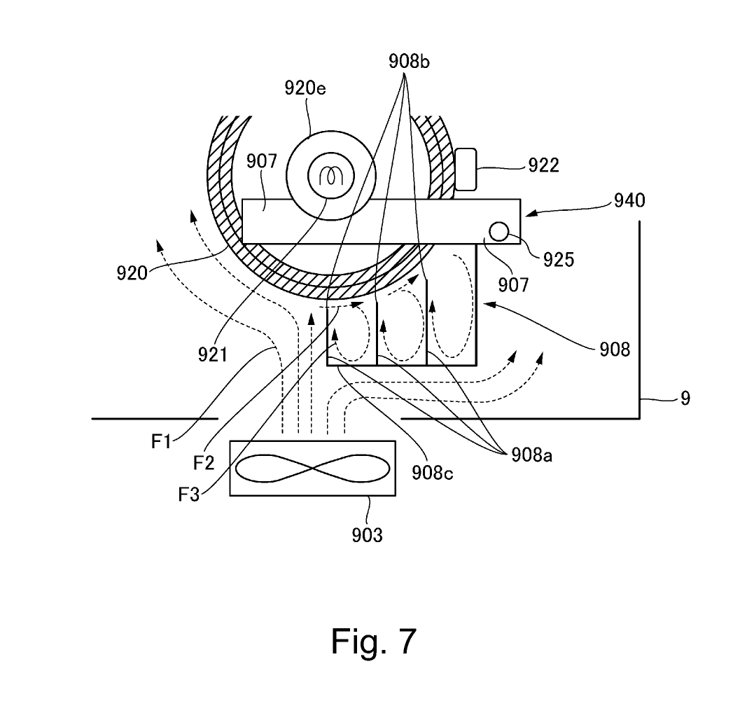

FIG. 6 is an illustration of a flow of air during the stand-by. FIG. 7 is an illustration of the flow of air during the image formation. In FIGS. 6 and 7, the air flow assumed in an enlarged sectional view of the wind shielding member 908 is indicated.

As shown in FIG. 6, when cooled air is blown from the cooling fan 903 toward the pressing roller 920, a part of the cooled air is an air flow F1 flowing along the surface of the pressing roller 920 or along an outside of the wind shielding member 908. The air flow F1 is principally an air flow used for cooling the pressing roller 920 and the fixing roller 910.

Another part of the cooled air is an air flow F2 flowing into the gap between the pressing roller 920 and the wind shielding member 908. A part of the air flow F2 forms an air flow F3 which is circulated by convection in the spaces defined by the wind shielding member 908 and the bottom plate 908c. The part of the air flow F2 enters the U-shaped space enclosed by the pair of wind shielding members 908, the bottom plate 908c and the pressing roller 920 and forms a spiral air flow (air current), so that the air flow passing through between an exit-side wind shielding member 908a and the pressing roller 920 is attenuated.

The air flow F2 likely to reach the thermistor 922 first passes through between the gap between the pressing roller 920 and the closest portions 908b of the wind shielding member 908 and is attenuated when flows into the first space 908m.

The air flow F2 flowing into the first space 908m while being attenuated is once diffused when flows into the first space 908. The diffused air flow is separated into the air flow F2 flowing into the second space 908m and an air flow F3 flowing toward openings at both ends with respect to a rotational axis direction while being circulated by convection and attenuated so as to swirl inside the first space 908m. As a result, the air flow F2 flowing into the second space 908m is largely attenuated compared with the air flow F2 when flowed into the first space 908m.

The air flow F2 flowing into the second space 908m while being attenuated is once diffused when flows into the second space 908. The diffused air flow is separated into the air flow F2 flowing into the third space 908m and an air flow F3 flowing toward openings at both ends with respect to a rotational axis direction while being circulated by convection and attenuated so as to swirl inside the second space 908m. As a result, the air flow F2 flowing into the third space 908m is largely attenuated compared with the air flow F2 when flowed into the second space 908m.

Thus, the air flow likely to reach the thermistor 922 is largely attenuated by repeating the attenuation, the diffusion and the separation into the air flows F2 and F3 every time when the air flow passes through the gap between the plurality of wind shielding plates 908a, arranged with intervals, and the pressing roller 920.

Thus, the air flow F2 finally reaching the thermistor 922 is remarkably suppressed compared with the first air flow F2. As a result, irrespective of ON/OFF of the cooling fan 903, the surface temperature of the pressing roller 920 can be satisfactorily detected using the thermistor 922.

An air flow attenuation effect by the wind shielding member 908 is also effective against the air blowing of the cooling fan 903 toward the thermistor 912 for detecting the surface temperature of the fixing roller 910. The wind shielding member 908 reduces also the cooled air toward the thermistor 912 and decreases an error of the surface temperature of the fixing roller 910 detected by the thermistor 912.

As shown in FIG. 7, the wind shielding member 908 moves together with the pressing arm 907, and therefore also during the image formation, an opposing state between the wind shielding member 908 and the pressing roller 920 is the same as that during the stand-by. The gap between the pressing roller 920 and the closest portions 908b of the wind shielding member 908 is the same between during the image formation and during the stand-by, and therefore, in each of the spaces 908m, a flowing manner of the air flows F1, F2 and F3 are reproduced as the same manner. For this reason, even during the image formation and during the stand-by, the surface temperature of the pressing roller 920 can be satisfactorily detected using the thermistor 922.

### (Effect of Embodiment 1)

In Embodiment 1, the wind shielding member suppresses the flowing of the air blowing of the cooling fan 903 to the thermistor 922, and therefore an erroneous temperature detection of the pressing roller 920 by the thermistor 922 can be reduced. It is possible to suppress a deviation in operation timing of the cooling fan 903 and a deviation in temperature adjustment of the pressing roller 920 with the erroneous temperature detection.

In Embodiment 1, the pressing arm 907 which is an example of a contact-and-separation mechanism moves the pressing roller 920 toward and away from the fixing roller 910. The pressing arm 907 which is an example of an interrelating mechanism moves the wind shielding member 908 with the rotational movement of the pressing arm 907 and maintains an opposing distance between the free end of the wind shielding member 908 and the pressing roller 920 at a constant value. For this reason, even in the spaced state and in the contact state, the thermistor 922 does not generate disturbance due to the air blowing of the cooling fan 903 toward the thermistor 922. The temperature of the pressing roller 920 is detected with high accuracy, so that it becomes possible to effect accurate temperature control.

In Embodiment 1, the pressing arm 907 is a lever member for moving the pressing roller 920 toward and away from the fixing roller 910 by rotating about a rotation shaft fixed in a positional relationship with the fixing roller 910 while supporting a rotation shaft of the pressing roller 920. For this reason, the number of parts is small, so that the fixing device can be constituted in a small size. The wind shielding member 908 has a structure disposed fixedly in the positional relationship with the pressing arm 907, and therefore, a mechanism exclusively for moving the wind shielding member 908 is not needed.

### Embodiment 2

FIG. 9 is an illustration of an arrangement of a wind shielding member in Embodiment 2. As shown in FIG. 9, a fixing device 9 in Embodiment 2 is the same as the fixing device in Embodiment 1 shown in FIG. 5 except that a wind shielding range of a wind shielding member 908 is different, and therefore in FIG. 6, constituent members common to those in Embodiment 1 are represented by the same symbols and will be omitted from redundant description.

As shown in FIG. 9, in Embodiment 2, compared with Embodiment 1, a length of the wind shielding member 908 with respect to the rotational axis direction of the pressing roller 920 is shortened and the wind shielding range in which the wind shielding member 908 shields the wind is limited to a periphery of the position where the thermistor 912 is disposed. For this reason, when compared with comparison example 1 shown in FIG. 9, cooling efficiency of the pressing roller 920 lowers, but the cooling efficiency is higher than that in Embodiment 1 shown in FIG. 5.

Incidentally, as shown in FIG. 7, in the case where the thermistor 912 is disposed at the plurality of positions of the fixing roller 910, the wind shielding member 908 is disposed at a plurality of portions with respect to the rotational axis direction of the pressing roller 920 correspondingly to the arrangement of the respective thermistors 912.

In either case, in Embodiment 2, as shown in FIG. 2, the wind shielding member 908 is, similarly as in Embodiment 1, fixed in the positional relationship with the pressing arm 907 rotating integrally with the pressing roller 920 about the rotation shaft 925. As a result, the gap between the free end of the wind shielding member 908 and the pressing roller 920 is unchanged between the press-contact state and the spaced state of the pressing roller 920 relative to the fixing roller 910, so that the wind shielding member 908 shields the air blowing of the cooling fan 903 toward the thermistors 912 and 922 so as to be the same level. Irrespective of the ON/OFF of the cooling fan 903 and the press-contact/spacing of the pressing roller 920, by eliminating the influence of the air blowing of the cooling fan 903 on the detection temperatures of the thermistors 912 and 922, the surface temperature of the fixing roller 910 and the pressing roller 920 can be maintained at constant levels.

In Embodiment 2, as regards the wind shielding member 908, the range, with respect to the rotational axis direction of the pressing roller 920, in which the wind shielding member 908 shields the air blowing of the cooling fan 903 flowing in the rotational direction of the pressing roller 930 is less than a length of the wind shielding member 908 with respect to the rotational axis direction of the pressing roller 920. However, the length of the wind shielding member 908 with respect to the rotational axis direction of the pressing roller 920 is a length in which the air blowing of the cooling fan 903 moves around the both ends of the wind shielding member 908 and does not reach the thermistor 912. Specifically, the length is 160 mm which is an example of not more than ½ of a length of 400 mm of the pressing roller 920. By this, not only a heat removing performance for the entire pressing roller 920 by the cooling fan 903 is enhanced, but also there is an effect on cooling for the non-sheet-passing portion temperature rise such that the end portion temperature of the fixing roller 910 rises.

In Embodiment 2, as regards the wind shielding member 908, both end portions thereof with respect to a direction along the rotational axis direction of the pressing roller 920 in a space 908m are closed. By this, when the air blowing of the cooling fan 903 flows into the space 908m, pressure in the space 908m is higher than that in the case where the both end portions are open, so that even when the length of the wind shielding member 908 is short, the shielding effect of the cooled air flowing the gap between the wind shielding member 908 and the pressing roller 920 is prevented from being impaired.

### Other Embodiments

The above-described Embodiments 1 and 2 are merely an example of the embodiments of the present invention, and the present invention is not limited to the constitutions and the control in the above-described embodiments.

Whether the constitution of Embodiment 1 is employed or the constitution of Embodiment 2 is employed can be selected depending on air blowing power of the cooling fan 903 and the responsiveness of the thermistor used.

In Embodiments 1 and 2, as the first rotatable member and the second rotatable member, the roller member is used in either case, but one or both of the first rotatable member and the second rotatable member may also be replaced with another rotatable member such as an endless belt member stretched by a plurality of stretching roller.

In Embodiments 1 and 2, as the detecting portion, the contact-type thermistor was employed, but a thermopile, a thermocouple, a semiconductor element, other temperature sensors, and the like may also be employed. These may be of a non-contact type.

In Embodiment 1, the opposing distance between the wind shielding member 908 and the pressing roller 920 was 1.5 mm, but setting of the gap between the wind shielding member 908 and the pressing roller 920 may appropriately be changed depending on the constitution of the fixing device 9, the air blowing amount of the cooling fan 903 and the responsiveness of the thermistor 912.

### INDUSTRIAL APPLICABILITY

According to the present invention, it is possible to provide a fixing device capable of suppressing action of the air by the air blowing portion on the detecting portion.

1. A fixing device comprising:
first and second rotatable members configured to form a nip for fixing a toner image on a recording material;
a detecting portion configured to detect a temperature of said first rotatable member;
an air blowing portion configured to blow air toward said first rotatable member;
a suppressing portion provided spaced from said first rotatable member along a circumferential direction of said first rotatable member and configured to suppress movement of the air from said air blowing portion toward said detecting portion,
wherein said suppressing portion includes a recessed portion opening toward a peripheral surface of said first rotatable member and a partitioning portion configured to partition said recessed portion into a plurality of spaces arranged in the circumferential direction of said first rotatable member.

2. A fixing device according to claim 1, wherein said suppressing portion includes another partitioning portion configured to partition said recessed portion into three spaces with respect to a circumferential direction of said first rotatable member.

3. A fixing device according to claim 1, wherein said recessed portion is closed at end portions thereof with respect to a longitudinal direction of said first rotatable member.

4. A fixing device according to claim 1, further comprising a contact and separation mechanism configured to move said first rotatable member toward and away from said second rotatable member,
wherein said contact and separation mechanism moves said suppressing portion while maintaining a positional relationship with said first rotatable member.

5. A fixing device according to claim 1, further comprising a heating portion configured to heat said first rotatable member and a closer configured to control energization to said heating portion depending on an output of said detecting portion so that the temperature of said first rotatable member is a toner image.

6. A fixing device according to claim 5, wherein said air blowing portion blows the air toward said first rotatable member when the temperature of said first rotatable member is not less than a predetermined temperature higher than the target temperature.

7. A fixing device according to claim 1, wherein said detecting portion is provided so as to contact a peripheral surface of said first rotatable member.
